(19) United States
(12) Patent Application Publication
(10) Pub. No.: US 2024/0429407 A1
(43) Pub. Date: Dec. 26, 2024

(54) PEM FUEL CELL

(71) Applicant: DAEGU GYEONGBUK INSTITUTE OF SCIENCE AND TECHNOLOGY, Daegu (KR)

(72) Inventor: Byung Rak SON, Daegu (KR)

(73) Assignee: DAEGU GYEONGBUK INSTITUTE OF SCIENCE AND TECHNOLOGY, Daegu (KR)

(21) Appl. No.: 18/686,589

(22) PCT Filed: Aug. 11, 2022
(86) PCT No.: PCT/KR2022/012059

§ 371 Date: Feb. 26, 2024

(30) Foreign Application Priority Data
Sep. 2, 2021 (KR) 10-2021-0117250

(51) Int. Cl. H01M 8/0258; H01M 8/0276; H01M 8/10; H01M 8/1004; H01M 8/241; H01M 8/2457

(52) U.S. Cl. CPC H01M 8/0258; H01M 8/0276; H01M 8/1004; H01M 8/241; H01M 8/2457; H01M 2008/1095

(57) ABSTRACT

Provided is a fuel cell-single cell including an anode separator, a cathode separator, an integrated gasket-membrane electrode assembly (MEA) which is disposed between the anode separator and the cathode separator and in which an ion exchange process takes place, an anode hydrogen supply channel disposed between the anode separator and the integrated gasket-membrane electrode assembly to allow hydrogen to be supplied to the anode separator therethrough, and a porous separator disposed between the cathode separator and the integrated gasket-membrane electrode assembly. The airtightness of the reaction gas, the efficiency of the ion exchange reaction, and the convenience of maintenance are improved by introducing the integrated gasket-membrane electrode assembly and the porous separator into the internal structure of the fuel cell.

### TECHNICAL FIELD

The present disclosure relates to a PEM (Proton Exchange Membrane) fuel cell, and more specifically, to a PEM fuel cell including an integrated gasket-membrane electrode assembly (MEA) and a porous separator.

### BACKGROUND ART

Recently, as the environmental pollution problem arising from securing energy through combustion of oil, coal, etc. has emerged, research has been actively conducted on ways to secure a sustainable form of energy that does not cause negative impacts on the environment.

In particular, there is increasing interest in fuel cells, which react hydrogen and oxygen to produce electrical energy. Such fuel cells are a prime example of a sustainable form of energy, as they do not emit hazardous substances that have a negatively impact on the environment and discharge water as a reaction product.

Such fuel cells include an anode separator where hydrogen molecules are decomposed into hydrogen ions and electrons, a cathode separator where oxygen molecules meet electrons, and an ion exchange membrane where an ion exchange reaction occurs.

Conventional fuel cells have a problem in that hydrogen and oxygen entering the fuel cells leak out through gaps between stacked fuel cell components, which results in reduced efficiency. In addition, due to the shape of an oxygen flow path of the cathode separator, oxygen introduced through the oxygen flow path does not receive an even surface pressure across the cross section of the fuel cell, causing problems of poor supply of oxygen or reduced efficiency due to the internal structure of the fuel cell.

### DETAILED DESCRIPTION OF THE DISCLOSURE

### Technical Problem

The present disclosure is devised to improve the above-described problems, and an objective of the present disclosure is to increase the airtightness of hydrogen and oxygen by integrating a gasket and a membrane electrode assembly, which are components of a fuel cell, to increase the uniformity and smoothness of oxygen supply by introducing a porous separator between a cathode separator and the integrated gasket-membrane electrode assembly, and to provide an effect of increasing the efficiency of the fuel cell by improving the reaction conditions according to an internal structure of the fuel cell.

### Technical Solution to Problem

The present disclosure is directed to a fuel cell-single cell including: an anode separator; a cathode separator; an integrated gasket-membrane electrode assembly (MEA) which is disposed between the anode separator and the cathode separator and in which an ion exchange process takes place; an anode hydrogen supply channel disposed between the anode separator and the integrated gasket-membrane electrode assembly to allow hydrogen to be supplied to the anode separator therethrough; and a porous separator disposed between the cathode separator and the integrated gasket-membrane electrode assembly. The present disclosure improves the airtightness of the reaction gas, the efficiency of the ion exchange reaction, and the convenience of maintenance by introducing the integrated gasket-membrane electrode assembly and the porous separator into the internal structure of the fuel cell.

### Advantageous Effects of Disclosure

According to various embodiments of the present disclosure, the integrated gasket-membrane electrode assembly is introduced, thereby preventing hydrogen and oxygen gases from leaking out. Additionally, if a problem occurs in the membrane electrode assembly in which the ion exchange process takes place, the integrated gasket-membrane electrode assembly is replaced without separate detailed disassembly process, thereby increasing the convenience of maintenance.

The porous separator according to various embodiments of the present disclosure is introduced, thereby allowing the surface pressure acting between the abutted cathode separator and integrated gasket-membrane electrode assembly to be evenly distributed. The porous separator may form an oxygen gas mixing flow path together with an oxygen gas flow path of the cathode separator, and may serve as a passage through which water produced from the ion exchange reaction is discharged to the outside. By condensing moisture in the pores and maintaining high humidity inside the fuel cell, appropriate ion exchange reaction conditions may be maintained.

### BRIEF DESCRIPTION OF DRAWINGS

FIG. 1 is an exploded perspective view illustrating the configuration of a fuel cell-single cell according to an embodiment of the present disclosure.

FIG. 2 is a perspective view illustrating an anode separator of a fuel cell-single cell according to an embodiment of the present disclosure.

FIG. 3 is a perspective view illustrating a cathode separator of a fuel cell-single cell according to an embodiment of the present disclosure.

FIG. 4 is an exploded perspective view illustrating the configuration of an integrated gasket-membrane electrode assembly of a fuel cell-single cell according to an embodiment of the present disclosure.

FIG. 5 is an exploded side view illustrating the configuration of an integrated gasket-membrane electrode assembly of a fuel cell-single cell according to an embodiment of the present disclosure.

FIG. 6 is a perspective view illustrating an integrated gasket-membrane electrode assembly of a fuel cell-single cell according to an embodiment of the present disclosure.

FIG. 7 is a perspective view illustrating a porous separator of a fuel cell-single cell according to an embodiment of the present disclosure.

FIG. 8 is an enlarged view illustrating a front surface and a porous portion of the porous separator of the fuel cell-single cell according to an embodiment of the present disclosure.

FIG. 9 is a partially enlarged side view illustrating the cathode separator, the integrated gasket-membrane electrode assembly, and the porous separator disposed therebetween in the fuel cell-single cell according to an embodiment of the present disclosure.

FIG. 10 is a perspective view illustrating a circular gasket of a fuel cell-single cell according to an embodiment of the present disclosure.

FIG. 11 illustrates, in perspective and side views, a fuel cell-single cell according to an embodiment of the present disclosure.

FIG. 12 is an exploded perspective view illustrating the configuration of a fuel cell stack according to an embodiment of the present disclosure.

FIG. 13 is a perspective view illustrating a fuel cell stack according to an embodiment of the present disclosure.

### BEST MODE

A PEM (Proton Exchange Membrane) fuel cell according to this embodiment to achieve the above-described objective may include a fuel cell-single cell including: an anode separator; a cathode separator; and an integrated gasket-membrane electrode assembly disposed between the anode separator and the cathode separator and in which an ion exchange process takes place; an anode hydrogen supply channel disposed between the anode separator and the integrated gasket-membrane electrode assembly to allow hydrogen to be supplied to the anode separator therethrough, and a porous separator disposed between the cathode separator and the integrated gasket-membrane electrode assembly.

In some embodiments, the fuel cell-single cell may further include a circular gasket coupled to opposite ends of the fuel cell-single cell to closely seal the anode separator, the anode hydrogen supply channel, the integrated gasket-membrane electrode assembly, the porous separator, and the cathode separator.

In some embodiments, the anode separator may have a plurality of hydrogen flow paths arranged in parallel, the cathode separator may have a plurality of oxygen flow paths arranged in parallel, and a portion of a hydrogen supply tube of the anode hydrogen supply channel may be connected to the anode separator.

In some embodiments, the integrated gasket-membrane electrode assembly may include a first gas diffusion layer through which hydrogen gas diffuses, a second gas diffusion layer through which oxygen gas diffuses, an ion exchange membrane disposed between the first gas diffusion layer and the second gas diffusion layer and in which an ion exchange process takes place, a first gasket disposed between the ion exchange membrane and the first gas diffusion layer, and a second gasket disposed between the ion exchange membrane and the second gas diffusion layer.

In some embodiments, the first gasket and the second gasket may respectively include a central opening having the same shape as the ion exchange membrane so that the ion exchange membrane is fitted and combined therein, and may have shapes to be engaged and combined with each other with the ion exchange membrane fitted therein.

In some embodiments, the porous separator may be provided with pores configured such that the wider a cross-section of the integrated gasket-membrane electrode assembly, the larger an area of the pores, and the narrower the cross-section of the integrated gasket-membrane electrode assembly, the smaller the area of the pores.

In some embodiments, the porous separator may have the same size as the anode separator and the cathode separator.

In some embodiments, the porous separator may have a larger area than the cross section of the integrated gasket-membrane electrode assembly.

In some embodiments, the porous separator may be integrally combined with the integrated-membrane electrode assembly.

In some embodiments, a fuel cell stack including a plurality of stacked fuel cell-single cells may be formed.

In some embodiments, the fuel cell stack may further include a current collector plate, an insulating plate, and an end plate at opposite ends of the plurality of stacked fuel cell-single cells.

### Mode of Disclosure

As the present disclosure may have various embodiments that are subject to various modifications, certain embodiments will now be illustrated in the drawings and described in more detail in the detailed description. However, this is not intended to limit the scope of the specific embodiments, and should be understood to include various modifications, equivalents, and/or alternatives to the embodiments of the present disclosure. In connection with the description of the drawings, like reference signs may be used for like components.

In describing the present disclosure, if it is determined that a detailed description of a related known function or configuration may unnecessarily obscure the gist of the present disclosure, a detailed description thereof will be omitted.

In addition, the following embodiments may be modified into various other forms, and the scope of the technical idea of the present disclosure is not limited to the following embodiments. Rather, these embodiments are provided to make the present disclosure more faithful and complete and to completely convey the technical idea of the present disclosure to those skilled in the art.

The terms used herein are merely used to describe specific embodiments and are not intended to limit the scope of rights. Singular expressions include plural expressions unless the context clearly dictates otherwise.

In the present disclosure, expressions such as “have,” “may have,” “includes,” or “may include” refer to the presence of the corresponding feature (e.g., numerical value, function, operation, or components such as part), and does not exclude the existence of additional features.

In the present disclosure, expressions such as “A or B,” “at least one of A or/and B,” or “one or more of A or/and B” may include all possible combinations of the items listed together. For example, “A or B,” “at least one of A and B,” or “at least one of A or B” includes (1) at least one A, (2) at least one B, or (3) both at least one A and at least one B.

Expressions such as “primary,” “secondary,” “first,” or “second,” used herein may designate various components regardless of order and/or importance, and may be only used to distinguish one component from other components and do not limit the components.

It will be understood that when a component (e.g., a first component) is referred to as being “(operatively or communicatively) coupled with/to” or “connected to” another component (e.g., a second component), the component may be directly coupled or connected to the other component, or an intervening component (e.g., a third component) may be present therebetween.

In contrast, it should be understood that when a component (e.g., a first component) is referred to as being “directly coupled” or “directly connected” to another component, there is no intervening component (a third component) present.

As used herein, the expression “configured (or set) to” may be used interchangeably with, for example, “suitable for,” “having the capacity to,” “designed to,” “adapted to,” “made to,” or “capable of,” depending on the situation. The term “configured (or set) to” may not necessarily mean “specifically designed to” in hardware.

Instead, in some situations, the expression “a device configured to” may mean that the device is “capable of” working with other devices or components.

Meanwhile, various elements and areas in the drawing are schematically drawn. Accordingly, the technical idea of the present disclosure is not limited by the relative sizes or spacing described in the attached drawings.

The embodiments of the present disclosure will now be described in detail with reference to the attached drawings to allow those skilled in the art to which the present disclosure pertains to easily implement the embodiments.

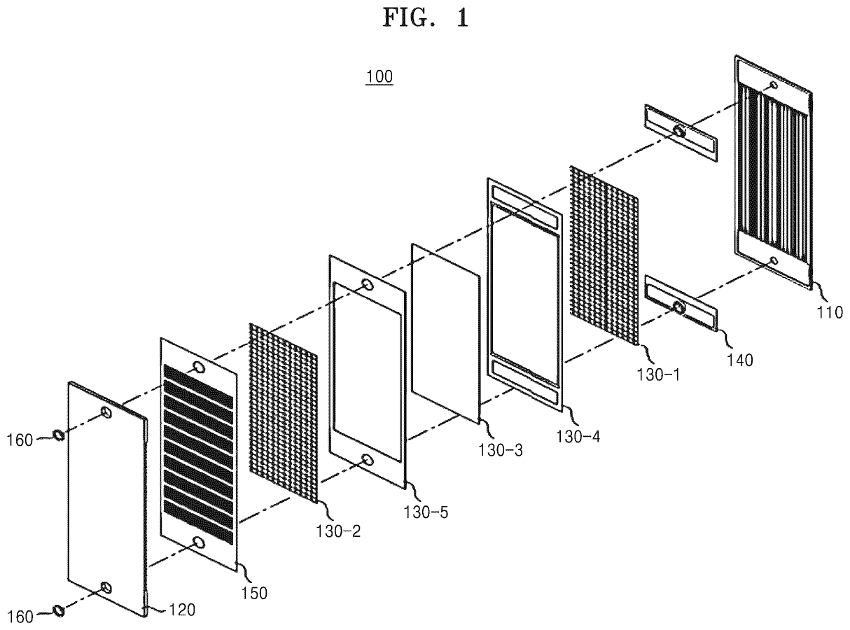

FIG. 1 is an exploded perspective view illustrating the configuration of a fuel cell-single cell according to an embodiment of the present disclosure.

Referring to FIG. 1, an anode separator 110 that supplies hydrogen gas to an anode and a cathode separator 120 that supplies oxygen gas to a cathode may be disposed at opposite ends of the single cell of the fuel cell. Between the anode separator 110 and the cathode separator 120, an anode hydrogen supply channel 140 that supplies hydrogen gas to the anode separator, an integrated gasket-membrane electrode assembly 130 in which an ion exchange process occurs, and a porous separator 150 through which oxygen gas introduced into a fuel cell flows may be disposed.

Here, the anode hydrogen supply channel 140 may be disposed between the integrated gasket-membrane electrode assembly 130 and the anode separator 110, and the porous separator 150 may be disposed between the integrated gasket-membrane electrode assembly 130 and the cathode separator 120.

The integrated gasket-membrane electrode assembly specifically includes a first gas diffusion layer 130-1 through which hydrogen gas diffuses, a first gasket 130-4, an ion exchange membrane 130-3 through which an ion exchange process takes place, and a second gasket 130-5, a second gas diffusion layer 130-2 through which oxygen gas diffuses, in a stacked structure.

In addition, the fuel cell-single cell according to an embodiment of the present disclosure may include a circular gaskets 160 coupled through holes located at upper and lower sides of the cross sections of the above members that are stacked up. The respective stacked fuel cell members are fixed in a tighter state by the circular gaskets to prevent hydrogen gas and oxygen gas flowing into the fuel cell from leaking out.

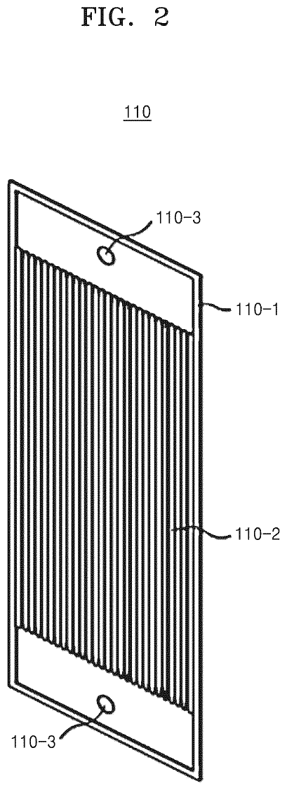

Hereinbelow, respective members constituting the fuel cell-single cell will be described in detail with reference to FIGS. 2 to 11.

FIG. 2 is a perspective view illustrating an anode separator 110 of a fuel cell-single cell according to an embodiment of the present disclosure.

The anode separator 110 may include a hydrogen gas flow path 110-2 on the surface so that hydrogen gas may be smoothly supplied and diffused therethrough to cause a reaction. The hydrogen gas flow path 110-2 may be a plurality of straight flow paths arranged in parallel so that hydrogen gas may be smoothly supplied therethrough. Although the hydrogen gas flow paths 110-2 may include a plurality of flow paths that are parallel in a vertical direction as illustrated in FIG. 2, the hydrogen gas flow paths are not limited thereto flow paths and may include a plurality of flow paths that are parallel in a horizontal direction. Additionally, the hydrogen gas flow paths 110-2 may include a plurality of flow paths that are parallel in a direction other than horizontal or vertical. Additionally, the plurality of hydrogen gas flow paths 110-2 may be formed in a form in which middle points of the parallel flow paths are pierced and connected together so that hydrogen gas may be smoothly supplied through the middle points.

The hydrogen gas flow paths 110-2 may have a square, rectangular, circular, or oval shape in section.

However, the hydrogen gas flow paths are not limited thereto and may have a structure and a cross section suitable for a smooth flow of hydrogen gas.

The anode separator 110 may include a frame 110-1 having a specified shape so that the anode separator may be stacked together with other members to form a fuel cell-single cell, and the anode separator 110 may have holes 110-3, into which the circular gaskets 160 may be coupled, at upper and lower sides of the frame 110-1, excluding the area where the hydrogen gas flow paths 110-2 are disposed. However, if the circular gasket 160 has an oval or polygonal shape rather than a circular shape, the hole into which the circular gasket 160 is inserted may have a corresponding shape.

The frame 110-1 of the anode separator 110 may have a rectangular shape as illustrated in FIG. 2, but is not limited to this and may have a circular, oval, or polygonal shape.

Here, an anode hydrogen supply channel 140 that supplies hydrogen gas to the anode separator 110 may be disposed and coupled to the upper and lower sides of the frame 110-1, excluding the area where the hydrogen gas flow paths 110-2 of the anode separator 110 are disposed. The anode hydrogen supply channel 140 serves as a passage for hydrogen gas, and a portion of the anode hydrogen supply channel 140 may be configured as being connected to the hydrogen gas flow paths 110-2 of the anode separator 110 to allow the hydrogen gas to be supplied to the anode separator.

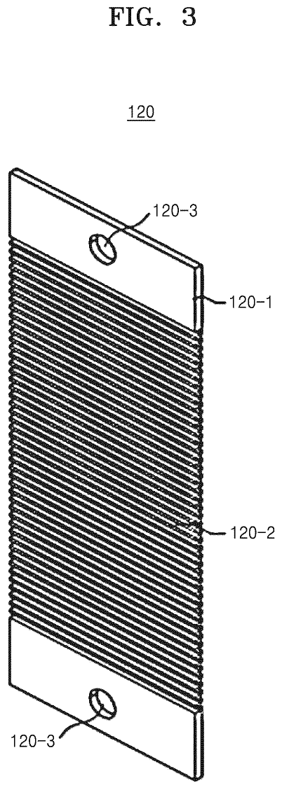

FIG. 3 is a perspective view illustrating a cathode separator 120 of a fuel cell-single cell according to an embodiment of the present disclosure.

The cathode separator 120 may include an oxygen gas flow path 120-2 on the surface so that oxygen gas may be smoothly supplied and diffused therethrough to cause a reaction. The oxygen gas flow path 120-2 may be a plurality of straight flow paths arranged in parallel so that hydrogen gas may be smoothly supplied therethrough. Although the oxygen gas flow paths 120-2 may include a plurality of flow paths that are parallel in a horizontal direction as illustrated in FIG. 3, the oxygen gas flow paths are not limited thereto flow paths and may include a plurality of flow paths that are parallel in a vertical direction. Additionally, the oxygen gas flow paths 120-2 may include a plurality of flow paths that are parallel in a direction other than horizontal or vertical. Additionally, the plurality of oxygen gas flow paths 120-2 may be formed in a form in which middle points of the parallel flow paths are pierced and connected together so that oxygen gas may be smoothly supplied through the middle points.

The oxygen gas flow paths 120-2 may have a square, rectangular, circular, or oval shape in section.

However, the oxygen gas flow paths are not limited thereto and may have a structure and a cross section suitable for a smooth flow of oxygen gas.

The cathode separator 120 may include a frame 120-1 having a specified shape so that the cathode separator may be stacked together with other members to form a fuel cell-single cell, and the cathode separator 120 may have holes 120-3, into which the circular gaskets 160 may be coupled, at upper and lower sides of the frame 120-1, excluding the area where the oxygen gas flow paths 120-2 are disposed. However, if the circular gasket 160 has an oval or polygonal shape rather than a circular shape, the hole into which the circular gasket 160 is inserted may have a corresponding shape.

The frame 120-1 of the cathode separator 120 may have a rectangular shape as illustrated in FIG. 2, but is not limited to this and may have a circular, oval, or polygonal shape.

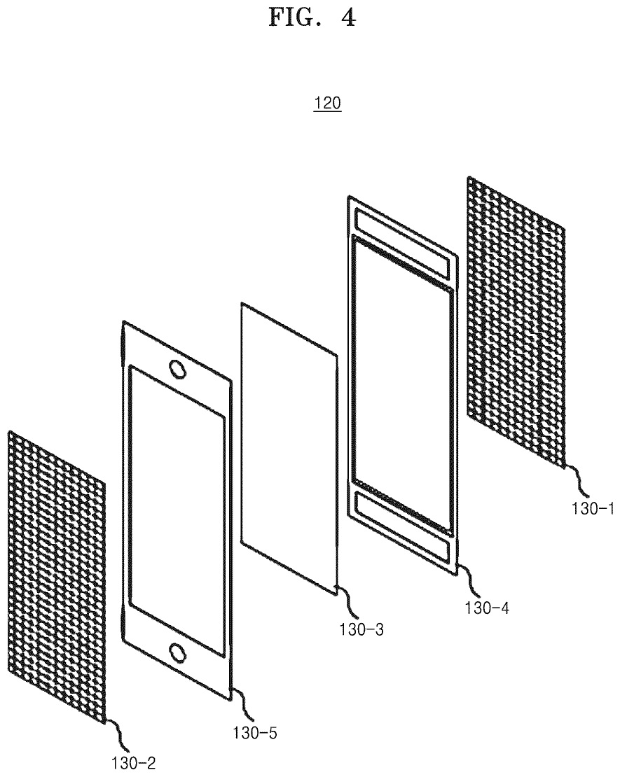

FIG. 4 is an exploded perspective view illustrating the configuration of an integrated gasket-membrane electrode assembly 130 of a fuel cell-single cell according to an embodiment of the present disclosure.

Referring to FIG. 4, the integrated gasket-membrane electrode assembly may include a stacked structure of a first gas diffusion layer 130-1, a first gasket 130-4, an ion exchange membrane 130-3, a second gasket 130-5, and a second gas diffusion layer 130-2.

The first gas diffusion layer 130-1 and the second gas diffusion layer 130-2 are located on the outermost side of the integrated gasket-membrane electrode assembly to allow hydrogen introduced from the outside to diffuse through the first gas diffusion layer 130-1 and oxygen gas introduced from the outside to diffuse through the second gas diffusion layer 130-2. As such, the first gas diffusion layer 130-1 and the second gas diffusion layer 130-2 serve to allow hydrogen gas and oxygen gas to diffuse and flow to the ion exchange membrane 130-3 where a reaction occurs.

The ion exchange membrane 130-3 may not allow electrons to pass through, but may allow only hydrogen ions to pass through. Referring to FIG. 4, at the center of the integrated gasket-membrane electrode assembly in which the first gas diffusion layer 130-1, the first gasket 130-4, the ion exchange membrane 130-3, the second gasket 130-5, and the second gas diffusion layer 130-2 are stacked in this order, hydrogen ions pass through the ion exchange membrane 130-3 and combine with oxygen gas and electrons to generate water and heat, producing electrical energy.

Here, a catalyst layer (not shown) may be disposed between the first gas diffusion layer 130-1 and the ion exchange membrane 130-3, and another catalyst layer (not shown) may be disposed between the second gas diffusion layer 130-2 and the ion exchange membrane 130-3. The catalyst layer may include Ni, Pt, Ag, polymer electrolyte, binder, etc. However, it is not limited to this and may include other compounds that enable the ion exchange process to proceed smoothly.

The first gasket 130-4 may be disposed between the first gas diffusion layer 130-1 and the ion exchange membrane 130-3, and the second gasket 130-5 may be disposed between the second gas diffusion layer 130-2 and the ion exchange membrane 130-3.

The first gasket 130-4 and the second gasket 130-5 may function as a support to stably couple the first gas diffusion layer 130-1, the ion exchange membrane 130-3, and the second gas diffusion layer 130-2, and as a seal to prevent hydrogen gas and oxygen gas from leaking out of the fuel cell.

The first gasket 130-4 and the second gasket 130-5 may include synthetic resin, rubber, ceramic, metal, etc. However, it is not limited to this and may include various materials with excellent heat resistance and mechanical strength.

The first gasket 130-4 may have holes at the upper and lower sides of the frame so that the upper and lower sides of the second gasket 130-5 may be fitted and coupled into the holes. Referring to FIG. 4, these holes are formed in a rectangular shape along the frame contour at the upper and lower sides of the first gasket 130-4, but are not limited thereto, and may be formed in various shapes such as a circular, oval, square, or polygonal shape so that the upper and lower sides of the second gasket 130-5 may be fitted and coupled into the holes. In addition, the first gasket 130-4 may include a central opening and a thin peripheral frame surrounding the central opening, so that the first gas diffusion layer 130-1 and the ion exchange membrane 130-3 may be disposed around the central opening.

The second gasket 130-5 may have a corresponding shape so that the upper and lower portions of the frame may be fitted into the rectangular holes formed in the upper and lower portions of the first gasket 130-4. In addition, the second gasket 130-5 may have holes at the upper and lower sides thereof to allow the circular gaskets 160 to be coupled thereto. However, if the circular gasket 160 has an oval or polygonal shape rather than a circular shape, the hole into which the circular gasket 160 is fitted may have a corresponding shape.

The second gasket 130-5 may have a central opening so that the second gas diffusion layer 130-2 and the ion exchange membrane 130-3 may be disposed around the central opening of the second gasket and fitted and coupled into the central opening of the second gasket 130-5.

The integrated gasket-membrane electrode assembly 130 may include an integrated structure in which the first gas diffusion layer 130-1, the first gasket 130-4, the ion exchange membrane 130-3, the second gasket 130-5, and the second gas diffusion layer 130-2 are compressed into a stacked structure.

Such an integrated gasket-membrane electrode assembly 130 may be formed by disposing the ion exchange membrane 130-3 between the first gasket 130-4 and the second gasket 130-5 so that the upper and lower sides of the frames of the first gasket 130-4 and the second gasket 130-5 may be fitted and coupled together, and the ion exchange membrane 130-3 may be fitted and coupled into the central openings of the first gasket 130-4 and the second gasket 130-5. Additionally, the first gas diffusion layer 130-1 and the second gas diffusion layer 130-2 may be fitted and coupled into the central openings of the first gasket 130-4 and the second gasket 130-5.

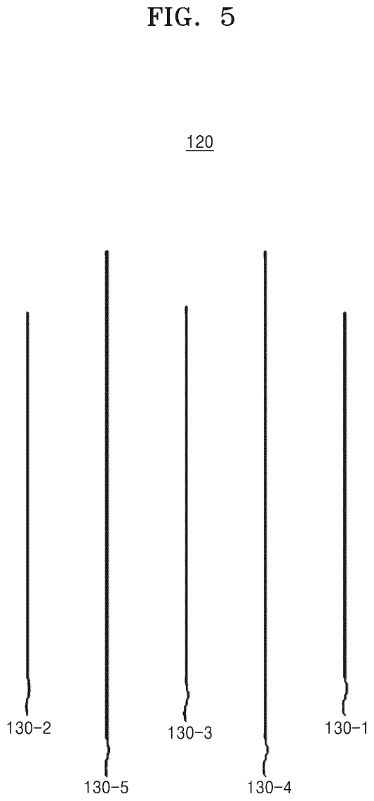

FIG. 5 is an exploded side view illustrating the configuration of an integrated gasket-membrane electrode assembly 130 of a fuel cell-single cell according to an embodiment of the present disclosure.

Referring to FIG. 5, the horizontal and vertical lengths of the first gasket 130-4 and the second gasket 130-5 may have a value greater than the horizontal and vertical lengths of the first gas diffusion layer 130-1, the ion exchange membrane 130-3, and the second gas diffusion layer 130-2 such that the first gas diffusion layer 130-1, the ion exchange membrane 130-3, and the second gas diffusion layer 130-2 may be fitted and coupled into the central openings of the first gasket 130-4 and the second gasket 130-5.

In addition, the horizontal and vertical lengths and cross-sectional areas of the first gas diffusion layer 130-1, the ion exchange membrane 130-3, and the second gas diffusion layer 130-2 may all the same or have no substantially large difference such that the first gas diffusion layer 130-1, the ion exchange membrane 130-3, and the second gas diffusion layer 130-2 may be fitted and coupled into the central openings of the first gasket 130-4 and the second gasket 130-5.

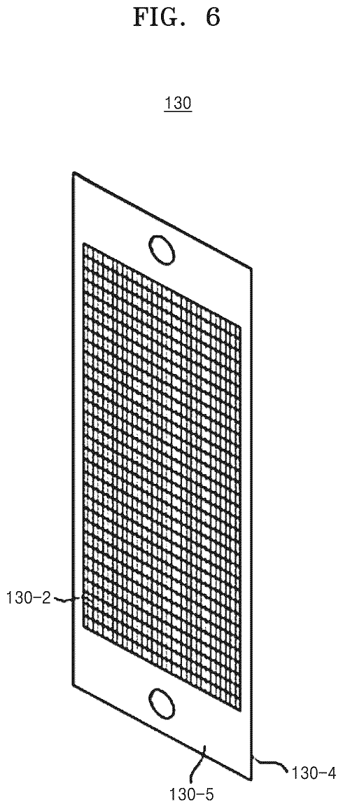

FIG. 6 is a perspective view illustrating an integrated gasket-membrane electrode assembly 130 of a fuel cell-single cell according to an embodiment of the present disclosure.

Referring to FIG. 6, the second gas diffusion layer 130-2 may be fitted and coupled into the central opening of the second gasket 130-5. The second gasket 130-5 may be configured to abut against the first gasket 130-4 so as to form an integrated gasket-membrane electrode assembly. Although not illustrated in FIG. 6, the first gas diffusion layer 130-1 may be fitted and coupled into the central opening of the first gasket 130-4.

As such, the gasket-membrane electrode assembly may be integrated to prevent hydrogen gas and oxygen gas from leaking out, and as for maintenance, easy maintenance may be performed by replacing the integrated gasket-membrane electrode assembly 130 without separately replacing the first gas diffusion layer 130-1, the first gasket 130-4, the ion exchange membrane 130-3, the second gasket 130-5, and the second gas diffusion layer 130-2.

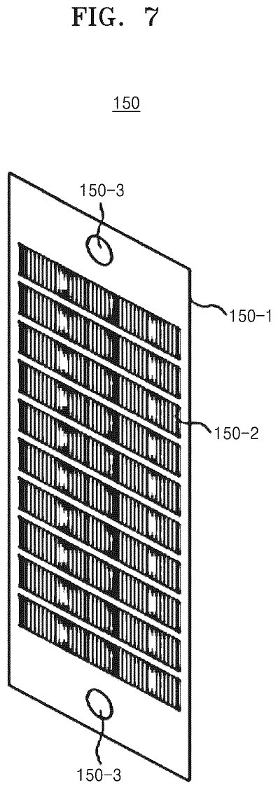

FIG. 7 is a perspective view illustrating a porous separator 150 of a fuel cell-single cell according to an embodiment of the present disclosure.

Referring to FIG. 7, the porous separator 150 may include a frame 150-1, porous sections 150-2, and holes 150-3 into which the circular gaskets 160 may be coupled.

The frame 150-1 may be abutted against and coupled to other stacked members of the fuel cell, may serve to support the porous separator, and may be provided, on the upper and lower sides of the frame 150-1, with holes 150-3 into which the circular gaskets 160 may be fitted and coupled. However, if the circular gasket 160 has an oval or polygonal shape rather than a circular shape, the holes into which the circular gaskets 160 are fitted may have a corresponding shape.

The horizontal and vertical lengths of a peripheral portion of the frame 150-1 of the porous separator 150 may have the same value as those of the first gasket 130-4 and the second gasket 130-5 of the integrated gasket-membrane electrode assembly 130. In this case, the porous separator 150 and the integrated gasket-membrane electrode assembly 130 may be more stably coupled without misalignment, and surface pressure may be applied evenly across the entire cross section of the fuel cell-single cell.

The porous sections 150-2 may each include numerous fine-sized pores. The porous sections 150-2 may be adjacent to the second gas diffusion layer 130-2 of the integrated gasket-membrane electrode assembly 130, and oxygen gas diffuses and passes through the porous sections 150-2.

The total area of the porous sections 150-2 may be greater than or equal to the area of the second gas diffusion layer 130-2 of the integrated gasket-membrane electrode assembly 130 disposed adjacent thereto. Accordingly, the porous separator 150 disposed between the cathode separator 120 and the second gas diffusion layer 130-2 may serve to facilitate a smooth supply of oxygen gas without interruption.

The porous sections 150-2 of the porous separator 150 may serve as a mixing flow path through which oxygen gas is supplied together with the oxygen gas flow paths 120-2 of the cathode separator 120. Oxygen gas supplied through the plurality of oxygen gas flow paths 120-2 arranged in parallel in the cathode separator 120 is mixed and separated while flowing through the porous sections 150-2 of the porous separator 150, so that the oxygen gas may be spread evenly across the entire cross section of the fuel cell-single cell.

The porous sections 150-2 of the porous separator 150 allows water generated as a product of the ion exchange process in the integrated gasket-membrane electrode assembly 130 to be smoothly discharged, while condensing moisture in numerous pores 150-4, thereby maintaining high humidity inside the fuel cell-single cell to maintain optimal conditions for the ion exchange reaction to occur.

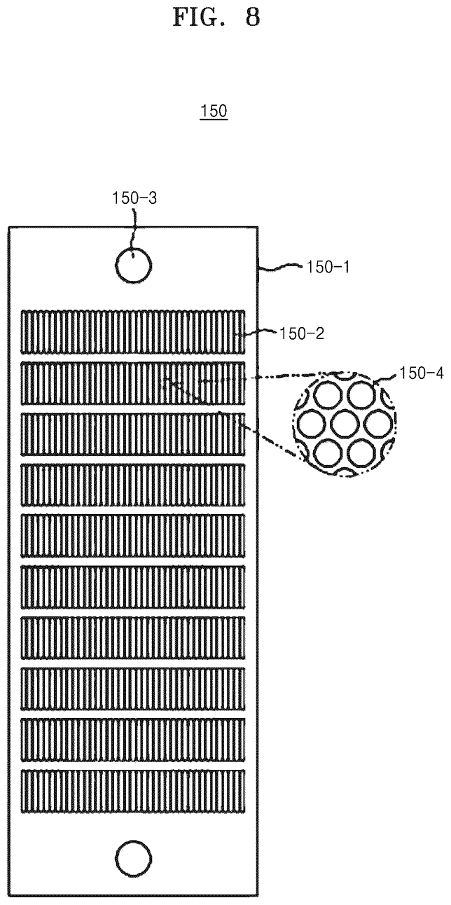

FIG. 8 is an enlarged view illustrating a front surface and porous sections of a porous separator 150 of a fuel cell-single cell according to an embodiment of the present disclosure.

The porous sections 150-2 may each include fine-sized pores 150-4. The diameter of the pore 150-4 may range from nano to micro in unit, and as illustrated in FIG. 8, the pore may have a circular shape, or may also have a polygonal shape such as a triangle, square, pentagon, or hexagon.

The size and shape of the pores 150-4 are not limited thereto-described embodiments, and may be configured to have the size and shape allowing oxygen gas to spread evenly over the entire surface and flow therethrough.

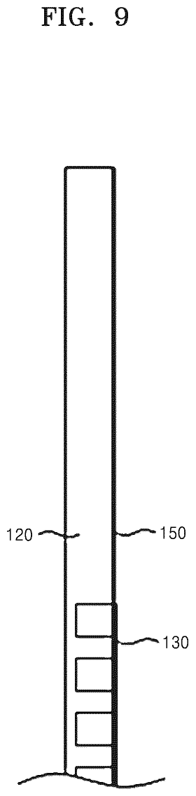

FIG. 9 is a partially enlarged side view illustrating a cathode separator 120, an integrated gasket-membrane electrode assembly 130, and a porous separator 150 disposed therebetween in a fuel cell-single cell according to an embodiment of the present disclosure.

Referring to FIG. 9, the porous separator 150 may be disposed adjacent to the second gas diffusion layer 130-2 of the integrated gasket-membrane electrode assembly 130 on one side, and adjacent to the oxygen gas flow paths 120-2 of the cathode separator 120 on the opposite side.

When the oxygen gas flow paths 120-2 including passages, through which oxygen gas is supplied, and walls, are disposed adjacent to the integrated gasket-membrane electrode assembly 130, only the portion of the integrated gasket-membrane electrode assembly against which the walls of the oxygen gas flow paths 120-2 abut is subjected to greater pressure, so that uniform surface pressure may not be applied across the entire cross section of the integrated gasket-membrane electrode assembly 130. In some embodiments, when the porous separator 150 is disposed between the cathode separator 120 and the integrated gasket-membrane electrode assembly 130 as illustrated in FIG. 9, the pressure of the walls of the oxygen gas flow paths 120-2 of the cathode separator 120 applied to the integrated gasket-membrane electrode assembly 130 may be evenly distributed through the porous separator 150, so that the ion exchange reaction may be performed evenly over the entire area, and the electrical energy production efficiency of the fuel cell-single cell may be increased.

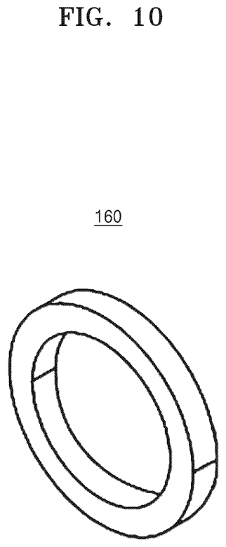

FIG. 10 is a perspective view illustrating a circular gasket of a fuel cell-single single cell according to an embodiment of the present disclosure.

The fuel cell-single cell according to an embodiment of the present disclosure may include circular gaskets 160 coupled through holes located at the upper and lower sides of the cross sections of the above-mentioned members that are stacked up. The respective stacked fuel cell members are fixed in a tighter state by the circular gaskets to prevent hydrogen gas flowing into the fuel cell from leaking out.

Although the circular gasket 160 may have a circular ring structure as illustrated in FIG. 10, the shape thereof is not limited thereto and may include an oval or polygonal shape in cross section in some embodiments.

The circular gasket 160 may include synthetic resin, rubber, ceramic, metal, etc. However, the circular gasket is not limited thereto and may include various materials with excellent heat resistance and mechanical strength.

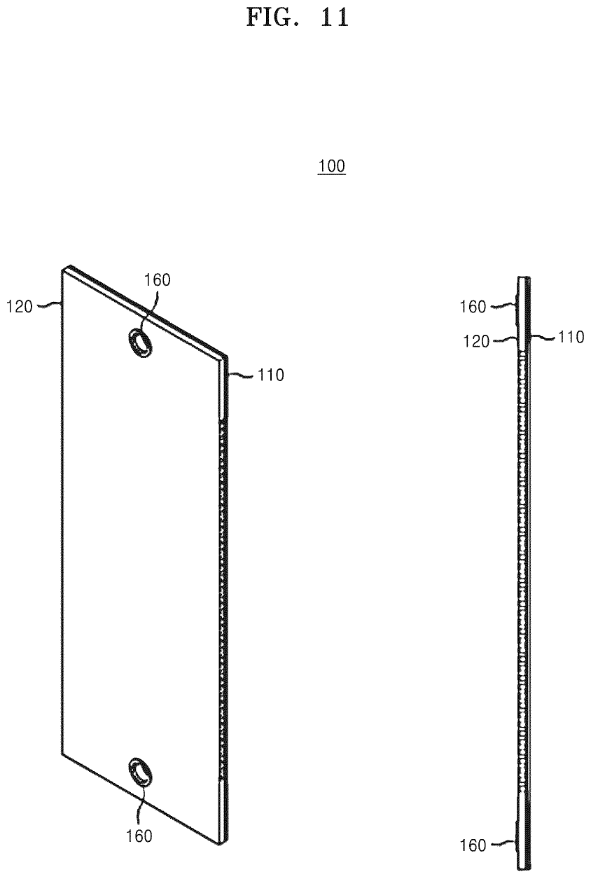

FIG. 11 illustrates, in perspective and side views, a fuel cell-single cell according to an embodiment of the present disclosure.

The fuel cell-single cell may be formed such that an anode separator 110 and a cathode separator 120 are disposed on the outermost side, and an anode hydrogen supply channel 140, an integrated gasket-membrane electrode assembly 130, and a porous separator 150 are provided between the anode separator 110 and the cathode separator 120. In addition, circular gaskets 160 are fitted into the upper and lower sides of the above members so that the members may be tightly coupled in a stacked structure.

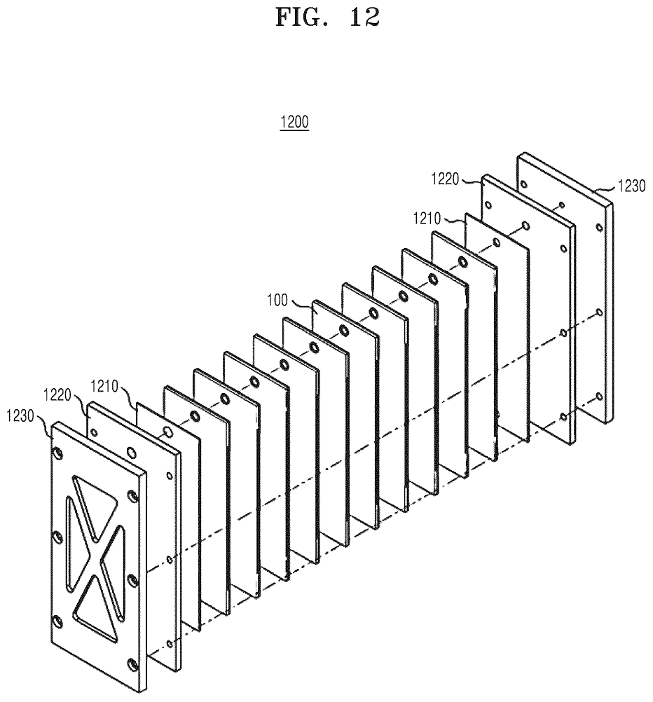

FIG. 12 is an exploded perspective view illustrating the configuration of a fuel cell stack 1200 according to an embodiment of the present disclosure.

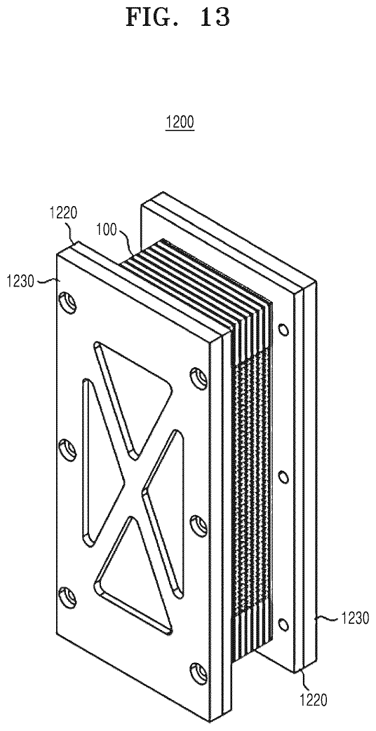

FIG. 13 is a perspective view illustrating a fuel cell stack 1200 according to an embodiment of the present disclosure.

Referring to FIGS. 12 and 13, a single fuel cell stack may be configured by coupling a plurality of fuel cell-single cells 100 in a stacked structure, and coupling current collector plates 1210, insulating plates 1220, and end plates 1230 to opposite ends of the stacked structure.

The end plates 1230 may have a cross-sectional area larger than that of the fuel cell-single cell 100 in order to protect the fuel cell stack 1200 from external shock, and may include a high-strength material.

When the fuel cell stack 1200 is formed by stacking the plurality of fuel cell-single cells 100 as illustrated in FIGS. 12 and 13, if a problem occurs inside the fuel cell, only the problematic fuel cell-single cell 100 may be replaced to improve convenience in maintenance.

### INDUSTRIAL APPLICABILITY

According to an embodiment of the present disclosure, the fuel cell-single cell may be provided. In addition, the provision of the fuel cell-single cell according to an embodiment of the present disclosure may enables a sustainable energy security technology.

1. A fuel cell-single cell comprising:
an anode separator;
a cathode separator;
an integrated gasket-membrane electrode assembly (MEA) which is disposed between the anode separator and the cathode separator and in which an ion exchange process takes place;
an anode hydrogen supply channel disposed between the anode separator and the integrated gasket-membrane electrode assembly to allow hydrogen to be supplied to the anode separator therethrough; and
a porous separator disposed between the cathode separator and the integrated gasket-membrane electrode assembly.

2. The fuel cell-single cell of claim 1, further comprising
a circular gasket coupled to opposite ends of the fuel cell-single cell to closely seal the anode separator, the anode hydrogen supply channel, the integrated gasket-membrane electrode assembly, the porous separator, and the cathode separator.

3. The fuel cell-single cell of claim 2, wherein
the anode separator includes a plurality of hydrogen flow paths arranged in parallel,
the cathode separator includes a plurality of oxygen flow paths arranged in parallel, and
a portion of a hydrogen supply tube of the anode hydrogen supply channel is connected to the anode separator.

4. The fuel cell-single cell of claim 3, wherein
the integrated gasket-membrane electrode assembly includes:
a first gas diffusion layer through which hydrogen gas diffuses;
a second gas diffusion layer through which oxygen gas diffuses;
an ion exchange membrane which is disposed between the first gas diffusion layer and the second gas diffusion layer and in which an ion exchange process takes place;
a first gasket disposed between the ion exchange membrane and the first gas diffusion layer; and
a second gasket disposed between the ion exchange membrane and the second gas diffusion layer.

5. The fuel cell-single cell of claim 4, wherein
each of the first gasket and the second gasket
includes a central opening having the same shape as the ion exchange membrane so that the ion exchange membrane is fitted and combined therein, and the first gasket and the second gasket have shapes to be engaged and combined with each other with the ion exchange membrane fitted therein.

6. The fuel cell-single cell of claim 3, wherein
the porous separator is provided with pores configured such that the wider a cross-section of the integrated gasket-membrane electrode assembly, the larger an area of the pores, and
the narrower the cross-section of the integrated gasket-membrane electrode assembly, the smaller the area of the pores.

7. The fuel cell-single cell of claim 6, wherein
the porous separator has the same size as the anode separator and the cathode separator.

8. The fuel cell-single cell of claim 7, wherein
the porous separator has a larger area than the cross section of the integrated gasket-membrane electrode assembly.

9. The fuel cell-single cell of claim 1, wherein
the porous separator is integrally combined with the integrated-membrane electrode assembly.

10. A fuel cell stack comprising: a plurality of stacked fuel cell-single cells of claim 4.

11. The fuel cell stack of claim 10, further comprising:
a current collector plate, an insulating plate, and an end plate, at opposite ends of the plurality of stacked fuel cell-single cells.
